(19) United States
(12) Patent Application Publication
(10) Pub. No.: US 2011/0033691 A1
(43) Pub. Date: Feb. 10, 2011

(54) COMPOSITION, METHOD AND DEVICE FOR DIGITALLY COATING TEXTILE

(75) Inventors: Johannes Antonius Craamer, Ijist (NL); James E. Fox, Cambridge (GB)

Correspondence Address: HOWREY LLP-EU, C/O IP DOCKETING DEPARTMENT, 1299 Pennsylvania Avenue, NW, Room B-3, Washington, DC, 20004-2402, US

(73) Assignee: Ten Cate Advanced Textiles B.V., Nijverdal (NL)

(21) Appl. No.: 12/906,289

(22) Filed: Oct. 18, 2010

Related U.S. Application Data
(63) Continuation of application No. 11/886,876, filed on Sep. 21, 2007.
Application No. 11/886,876 is a continuation-in-part of application No. 10/571,896, filed on Mar. 14, 2006.

(30) Foreign Application Priority Data
Sep. 22, 2003 (NL) 1024335
Nov. 28, 2003 (NL) PCT/NL03/00841
Mar. 22, 2005 (GB) 0505894.6

(51) Int. Cl. D06M 15/00; B05D 7/24; B32B 5/02; B82Y 99/00

(52) U.S. Cl. 428/221; 427/288; 252/8.61; 252/8.63; 252/8.62; 977/773; 977/961

(57) ABSTRACT

A finishing composition is described for deposition by dot-on-demand inkjet technique onto a textile substrate. The composition comprises a solution, dispersion or emulsion of a functional finishing agent in a vehicle, wherein the size of particles in the dispersion or emulsion of the finishing composition is less than about 2 microns. By ensuring sufficient fineness of the particles, effective and reliable droplet deposition may proceed without clogging. Of significance, the composition should not be subject to flocculation or sedimentation during use.

### CROSS REFERENCE TO RELATED APPLICATIONS

The present application is a continuation of U.S. patent application Ser. No. 11/886,876, filed on Sep. 22, 2007, which claims priority from PCT application number PCT/EP2006/060969, filed on Mar. 22, 2006 which further claims priority from United Kingdom application number GB 0505894.6 filed on Mar. 22, 2005. This application is also a continuation-in-part of U.S. patent application Ser. No. 10/571,896, filed on Mar. 14, 2006, which claims priority from PCT application serial number PCT/EP2004/010731 filed Sep. 22, 2004, which claims priority from Dutch application number 1024335 filed on 22 Sep. 2003 and also from PCT application number PCT/NL03/00841 filed on 28 Nov. 2003. The contents of all aforementioned applications are hereby incorporated by reference in their entirety.

### BACKGROUND OF THE INVENTION

1. Field of the Invention

The present invention relates to compositions for use in a device for digitally coating textile. In particular, it relates to finishing of textiles by digital droplet deposition using drop-on-demand inkjet (DoD) techniques. It relates furthermore to finishing compositions specially adapted to this purpose and methods of performing such finishing.

2. Description of the Related Art

Coating is one of the operations frequently performed during the production of textiles. Roughly five stages can be distinguished in such production; the fibre production; spinning of the fibres; the manufacture of cloth (for instance woven or knitted fabrics, tufted material or felt and non-woven materials); the upgrading of the cloth; and the production or manufacture of end products. Textile upgrading covers a number of operations such as preparing, bleaching, optically whitening, colouring (dyeing and/or printing), coating and finishing. These operations generally have the purpose of giving the textile the appearance and physical characteristics that are desired by the user. Coating of the textile is one of the more important techniques of upgrading and may be used to impart various specific characteristics to the resulting product. It may be used for making the substrate fireproof or flameproof, water-repellent and/or oil repellent, non-creasing, shrink-proof, rot-proof, non-sliding, fold-retaining and/or antistatic.

Conventional processes for upgrading textile are composed of (FIG. 1) a number of part-processes or upgrading steps, i.e. pre-treating the textile article (also referred to as the substrate), dyeing the substrate, coating the substrate, finishing the substrate and the post-treatment of the substrate.

One form of finishing is coating. Coating of a textile involves the application of a thin layer to the textile to endow it with particular functional properties such as to protect or increase the durability of the substrate. The usual techniques for applying a coating on solvent or water basis are the so-called “knife-over-roller”, the “dip” and the “reverse roller” screen coaters. A solution, suspension or dispersion of a polymer substance in water is usually applied to the cloth and excess coating is then scraped off with a doctor knife. For such procedures to be effective, the coating formulation must be in a highly viscous, pasty form. For many functionalities, it is not possible to bring the formulation into such a viscous state without adversely affecting the functionality. This may be due to the fact that thickening agents are incompatible with the functional chemical.

A further procedure sometimes employed for finishing of the textile is the use of immersion or bath techniques such as foularding. The textile is fully immersed in an aqueous solution containing the functional composition that is to be applied. Subsequent repeated cycles of drying, fixation and condensation are required to complete the operation. This leads to considerable use of resources, in particular water and energy. In general, the solutions, suspensions or dispersions used for such techniques have low concentrations of the desired functional composition

Each of the upgrading steps shown in FIG. 1 consists of a number of operations. Various treatments with different types of chemicals are required, depending on the nature of the substrate and desired end result.

For the upgrading steps of printing, dyeing and finishing four recurring steps can generally be distinguished which often take place in the same sequence. These treatments are referred to in the professional field as unit operations and include: impregnation (i.e. application or introduction of chemicals); reaction/fixing (i.e. binding chemicals to the substrate); washing (i.e. removing excess chemicals and auxiliary chemicals); and drying.

One drawback of the usual methods of upgrading is that per upgrading step (dyeing, coating, finishing) a number of cycles of unit operations have to be carried out to achieve the desired result. Three or more cycles of unit operations are often necessary for coating, which entails a relatively high environmental impact, a long throughput time and relatively high production costs. Four or more cycles of unit operations are even required for dyeing. The traditional dyeing process requires, for instance, the final operations of several rinses (washing and soaping) for rinsing out excess chemicals, such as thickening agent. Rinsing results in much use of water. Following on from the rinses is a drying process, usually consisting of a mechanical drying step using press-out rollers and/or vacuum systems followed by a thermal drying step, for instance using tenter-frames.

It is moreover usual at present to carry out the different upgrading steps of the textile in separate devices. This means that for instance the dyeing is performed in a number of paint baths specially suited for the purpose, the printing and coating are carried out in separate printing devices and coating machines, while finishing is carried out by yet another device. Because the different operations are carried out individually in separate devices, the treating of the textile requires a relatively large area, usually spread over different room areas.

It is thus desirable to provide methods of upgrading, i.e. dyeing, coating and finishing, a substrate of textile where the above stated drawbacks and other drawbacks associated with conventional processes are reduced. It is further desirable to provide compositions that are suitable for use in the aforementioned methods, and in particular coatings and finishings.

It has been suggested in a number of publications that a textile article may be printed using ink-jet printing technology to produce a graphic image. Ink formulations from the graphic (paper) printing sectors have generally been used for this purpose, as such formulations are already adapted for jet deposition. In particular, pigment particulate sizes and the relatively low solids contents make such inks most suitable for inkjet devices. Such formulations are not however entirely suitable for application to all textiles, in particular those where considerable absorbency is encountered. In the past, textile articles have been pretreated with a coating onto which ink droplets may be applied using standard graphic printing techniques. A process is known from U.S. Pat. No. 4,702,742 in which a conventional printing device is used to print onto white cloth sheets. A further process is suggested in German patent application No. DE 199 30 866 in which both ink and a fixing solution are applied to a textile using a conventional inkjet head. Known methods are however only concerned with producing a graphic image and the formulations used are unsuitable as coatings for finishing.

It has also been suggested in unpublished PCT application Nos PCT/EP2004/010732 and PCT/EP2004/010731 both filed on 22 Sep. 2004 and hereby incorporated by reference in their entirety, to use inkjet type nozzles for the purpose of upgrading textile substrates. The proposed method makes use of a device comprising a number of nozzles for applying one or more substances to the textile, in addition to a conveyor for transporting the textile along the nozzles. The nozzles are ordered in a number of successively placed rows extending transversely of the transporting direction of the textile article. The textile article is guided along a first row of nozzles where it may receive a first functional layer. It may then be subsequently guided along second or third rows of nozzles for receiving further functional layers. Such a process may be referred to as digital droplet deposition.

The previously proposed method provides the option of applying chemical substances in concentrated form and with an exact dosage. The desired upgrading result can thereby be achieved in only a single cycle of unit operations. By applying the chemical substances in only one process run using a number of rows of nozzles placed in series, the efficiency per process run is increased considerably. Very uniform layers can also be applied due to the precision of dosage and nozzle control that is possible. The relatively high concentration with which the chemical substances may be applied furthermore makes interim drying almost unnecessary in many cases. The nozzles of the proposed device are preferably static with the textile being guided along the nozzles. This enables relatively high processing speeds and very precise forming of patterns. A further advantage of digital droplet deposition, is that it provides the possibility of on-demand delivery. In view of the small volumes of the reservoirs associated with the nozzles, a product change can also be realized within a very short time (less than two minutes). Subsequent sections of the same textile roll may thus be subjected to different finishing procedures almost at random. Smaller series of different textile articles can thus be processed on a single upgrading device without complicated change-over operations which can also have adverse environmental and productivity impact.

It has also been suggested in unexamined patent application No. JP61-152874 to Toray Industries, to impregnate a textile sheet with a functional composition in the form of dots. Various functional compositions are suggested including antibiotics, moisture absorbents, water repellents, antistatic agents, ultraviolet rays absorbents, infrared rays absorbents, optical whitening agents, swelling agents, solvents, saponifier, embrittlement agent, inorganic granules, metal granules, magnetic material, flame retardants, resistance, oxidants, reducing agents, perfumes, etc. The document indicates that traditional photogravure roll and screen print methods produce patterns of dots that may be too large, while in spraying techniques, the dot size and quantity of product deposited is difficult to control. The document proposes impregnating a textile with a functional composition in the form of dots, wherein a mean dot diameter is 30 to 500 microns and the occupied area ratio thereof is 3 to 95%. Although the document suggests the use of inkjet printing techniques, it identifies conventional inkjet devices as being unsuitable, in particular due to the high viscosity of traditional coating compositions. The document is concerned primarily with maintaining an identifiable droplet structure and preventing the droplets from running together. Furthermore, the document provides examples regarding the use of solutions but fails to address the problems of inkjet deposition of dispersions or suspensions.

Inkjet printers of various types are generally known for providing graphic images. Such printers may be desktop inkjet printers such as used in the office or home and are generally used for printing onto a particular type of paper substrate (printer paper), using small droplets (<20 pL) of water based inks containing colorants. Larger, industrial inkjet printers also exist for printing graphic images or date/batch codes onto products; these printers are typically printing onto non-porous substrates using solvent based inks containing colorants pigments. Such formulations are not however suitable for application onto most textiles in particular due to lack of colour fastness. In order to print onto textiles using inkjet techniques, textile articles have in the past been pretreated with a coating onto which ink droplets may be applied. For upgrading purposes, most currently used coatings and finishing compositions are unsuitable for deposition using inkjet techniques. Industrial inkjet printers and nozzles that produce large droplets are generally designed for use with solvent based, coloured inks. Furthermore, the droplet volumes that can be jetted are extremely low, in the order of 50 pL and mostly insufficient for textile finishing, where a significant penetration into the fabric is necessary. Typical finishing formulations are mostly water based and generally have particle sizes that can cause clogging of the nozzles. Additional problems with foaming, spattering and encrustation have been encountered. While indicating that conventional inkjet devices are unsuitable for applying finishing compositions, JP61-152874 fails to provide teaching regarding how this could be improved.

The technique described in detail in the above PCT applications makes use of the continuous inkjet (henceforth CIJ) technique. According to this technique, droplets are continuously formed in the inkjet nozzles and are charged on ejection. By using an electric field droplets may either be directed to the substrate or into a gutter for recycling. Use of CIJ makes it possible to generate 64,000 to 125,000 droplets per second per droplet jet. This large number of droplets and a number of mutually adjacent heads over the whole width of the textile results in relatively high productivity and quality of the printed result. In view of the high deposition speed, a production speed of the textile substrate of about 20 metres per minute can be realized. Although CIJ is most suitable in many cases, the cost per nozzle is generally very high. Furthermore, the specifications of the fluids to be jetted are sometimes very restrictive. They must be highly shear stable and must usually be provided with conductivity agents such as corrosive salts to enable them to carry the electrical charge. There is thus a desire to use other less complex and costly nozzles of the drop-on-demand (DoD) type.

Drop-on-demand inkjets devices are generally well known from the desktop printing field. Such devices are in principle relatively cheap although high prices may be charged for commercial cartridges! Two main principles of droplet formation are common: piezoelectric actuation, whereby a droplet is formed by resonating the fluid using a piezo-actuator; and thermal actuation (bubblejet), where a droplet is ejected by local boiling of the fluid. Other methods of droplet formation are known that may be considered to fall into the category of DoD, such as valvejet devices in which miniature valves allow controlled passage of minute volumes of fluid. The principle of operation is in all cases that the droplet is formed in response to a signal. This is thus distinguished from the continuous CU devices in which droplets are continuously produced.

Despite the advantages of the above proposed digital finishing procedures it has been found that most currently used coatings and upgrading compositions are unsuitable for deposition using inkjet techniques. Standard industrial inkjet nozzles are generally adapted for use with solvent-based reactive inks. Furthermore, the droplet volumes that can be jetted are extremely low, in the order of 50 pL and mostly insufficient for textile coating, where a significant penetration into the fabric is necessary. Typical coating formulations are mostly water based and generally have larger particle sizes that can cause clogging of the nozzles. Additional problems with foaming, spattering and encrustation have been encountered. When working with large numbers of nozzles operating at up to 30 KHz, reliability and fault free operation are of prime importance.

### BRIEF SUMMARY OF THE INVENTION

According to the invention there is provided a method of digitally forming a coating on a fibrous textile having mesh openings between adjacent fibres, wherein the method comprises continuously feeding the textile along a treatment path having a row of static coating nozzles arranged generally transversely across the path, the coating nozzles having outlet diameters of greater than about 70 microns, supplying the nozzles with a supply of a coating substance, individually controlling the nozzles to provide a substantially continuous stream of droplets of the coating substance and selectively directing the individual droplets to impinge on the textile to form a coating of pixels lying generally on the surface of the textile, each pixel covering at least four mesh openings and having a diameter of more than 100 microns. In this way, by using a larger nozzle and producing a droplet of sufficient size to cover four mesh openings, the droplet is adequately supported and spread or flattened across the textile surface. In the present context, the pixel formed by the droplet is considered to lie generally on the surface but may also enter the gaps between the fibres and may also partially surround the fibre at least on the side of the one surface in order to form an adequate bond therewith. The method is particularly applicable to woven or knitted textiles.

In the context of the present invention, the term “textile” is intended to encompass all forms of textile article, including woven textiles, knitted textiles and non-woven textiles. The term is intended to exclude fibrous articles having two-dimensional rigidity such as carpets, paper and cardboard. These fibrous articles, although sometimes referred to as textiles, are internally linked in such a way that they maintain a substantially fixed two-dimensional form. Even though they may be flexible in a third dimension they are not generally free to stretch or distort within the plane of the fibre layer, as is inherent in a true textile. Preferably the textile substrate is more than 100 meters in length and may be provided on a roll having a width of greater than 1 meter. Preferred textiles comprise cotton and/or other treated cellulosic fibres and also polyesters, polyamides, polyacrylnitril and acetates and triacetates or blends thereof

Preferably, the method further comprises feeding the textile along a second row of static nozzles also arranged generally transversely across the path, supplying the second row of nozzles with a supply of a second substance and individually controlling the nozzles to provide a substantially continuous stream of droplets of the second substance to the textile. The second row of nozzles may be used for another distinct upgrading step. In particular they may be used for printing, painting or dying the fabric. In particular, the second row may comprise nozzles having outlet diameters of less than 50 microns to produce a finer pixel definition. In an exemplary embodiment, high definition inkjet printing may be performed onto the coating after the textile has passed the first row of nozzles. Alternatively, the second substance may be applied prior to the coating substance. In this case, it may e.g. be received and absorbed within the fibrous structure and the coating may form a protective layer thereover.

In another embodiment of the invention, the second row of nozzles may be provided on the opposite side of the treatment path from the first row of nozzles. In this case, the second row may be substantially similar to the first row and the method may comprise applying the coating on both surfaces of the textile. Alternatively, the second row may be used to apply a different substance to the second surface of the textile whereby the finished textile exhibits different characteristics on each surface. Further rows of nozzles may be provided according to the treatments required.

It has been found extremely advantageous to use nozzles of the continuous inkjet multi-level deflection type. The method may thus comprise electrically charging or discharging the droplets, applying an electric field, and varying the electric field so as to deflect droplets such that they are individual deposited at suitable positions on the textile. In this way the precise position of each pixel may be carefully controlled e.g. the degree of overlap or the spacing therebetween. Using such techniques, each nozzle may generate as many as 100,000 droplets per second. In the case of a plurality of rows of nozzles, some rows may be of the multi-level deflection type while other rows may be of the binary level type.

Preferably, the nozzles are arranged over substantially a full width of the treatment path and the coating is applied substantially over a full width of the textile. This width may be in excess of 1 meter, however it is common to produce textiles having widths of up to 2.5 meters.

According to the present invention, there is further proposed a finishing composition for deposition by drop-on-demand inkjet technique onto a textile substrate, the composition comprising a dispersion or emulsion of a functional finishing agent in a vehicle, wherein the size of particles in the dispersion or emulsion of the finishing composition is less than 2 microns, preferably less than 1 micron, more preferably, less than 0.5 microns and not subject to flocculation or sedimentation. By ensuring sufficient fineness of the particles, effective and reliable droplet deposition may proceed without clogging. In the present context, the term particle is intended to cover solid particles as present in dispersion and also liquid or gel like phases, present e.g. in emulsions. It is noted that 2 microns is an approximate limit for particle size. Preferably, the maximum particle size will be less than 1 micron and for thermal inkjet may even need to be less than 0.5 microns. This value will also decrease as the percentage of solids in the composition increases above 10% but will rise as the nozzle diameter increases above 50 microns. It has been found most significant that the composition is of a consistent quality in this respect. Reference to particle size smaller than a given diameter is thus intended to refer to the D99 diameter or better. The composition should also not be subject to flocculation or sedimentation. This is intended to mean that the composition does not form particles greater than the given values during prolonged use or when the inkjet device is idle during its normal use. It is understood that many compositions may e.g. form sediment during prolonged storage but that this may be overcome by appropriate mixing arrangements.

In the context of the present invention, the term “finishing” is understood to mean processes that use auxiliary chemicals to change the functionality of a textile substrate rather than merely providing it with a coloured design or changing its visual appearance as is the case with conventional inkjet printing use inks and dyes. These finishing techniques are meant to improve the properties of and/or add properties to the final product. In this context it is understood to encompass both coating and impregnating and also to include other physical treatments that upgrade the functionality of the substrate. A distinction will henceforth be made between colouring and finishing. Where necessary, finishing may be understood to exclude treatments involving the deposition of particles that are applied to the substrate only because of their absorption properties between 400 and 700 nm.

The term “finishing composition” herein encompasses aqueous solutions, aqueous dispersions, organic solutions, organic dispersions, curable liquid mixtures and molten compounds that comprise an active component. According to an important advantage of the invention, the composition may be non-reactive with the substrate. In this manner, the composition may be applied to a greater diversity of substrates than would otherwise be the case.

According to a preferred embodiment for use with most common finishing agents, the vehicle is distilled, de-mineralized and/or de-ionized water, preferably present at between 60 and 90 wt % in the jetted composition.

According to the present invention there may also be provided a co-solvent. Suitable co-solvents include 2-pyrrolidone and isopropyl alcohol (IPA) present at from 0 to 5 wt %. The co-solvent can be used to improve the solubility of the finishing agent and/or its compatibility with other agents. Incompatibility between materials is a common formulation issue.

According to an important aspect of the present invention, considerably greater quantities of residual solids may be deposited according to the present composition. The finishing composition may comprise a total of residual solids in the jetted composition of more than 5 wt %, preferably more than 10 wt % and most preferably more than 15 wt %. This leads to considerably less energy use in drying and allows greater operational speed. Particularly in the case of piezo actuation, up to 20% residual solids may be jetted. In this example, the particular case of UV cure formulations is excluded, as with these formulations effectively 100% residual solids may remain on curing.

According to a yet further feature of the invention, the finishing composition may further comprise a humectant, preferably present at from 10 to 35 wt % in the jetted composition. The humectant may usually be in the form of a low volatility, high boiling point liquid that helps prevent crusting of the nozzle when the jets are not active. Suitable humectants for water based systems include polyhydric alcohols, glycols, polyethylene glycol, polypropylene glycol, glycerol and n-methyl pyrrolidone (NMP). Although with certain formulations it may appear that more than 5% humectant is being used, it is in fact the case that the same material may also be present as a viscosity modifier.

The finishing composition may also comprise a viscosity control agent, preferably present at from 2 to 15 wt % in the jetted composition. The viscosity control agent is an important ingredient for increasing reliability and quality as it controls the droplet formation and break up process. This material may also act as an active functional finishing component and provide some of the end user properties. Generally, high molecular weight polymers in solution should be avoided as their elasticity makes achieving jet break up difficult.. Preferably a viscosity of 2-15 centipoise is desired for piezo-actuation while for thermal-actuation the viscosity may be 1-4 centipoise, as measured at the normal operating temperature of the nozzle.

The finishing composition may further also comprise a wetting agent, preferably present at from 0.01 to 0.3 wt % in the jetted composition. The wetting agent may reduce foaming and may also lower surface tension and improve wetting of the nozzle and textile. Exemplary wetting agents include Surfynol 104E™, Dynol 604™ available from Air Products. Preferably, the surface tension of the composition is between 28 and 50 dynes/cm. If the surface tension is too high, the composition will not wet the internals of the print head properly and will leave air pockets, which will prevent reliable deposition. If the surface tension of the fluid is too low, the meniscus will not form properly in the print head nozzle and fluid will spontaneously flow onto the print head faceplate (known as faceplate wetting), which will also prevent reliable jetting.

Moreover, the finishing composition may also comprise a biocide, preferably present at up to 0.5 wt % in the jetted composition. Biocide may be used to prevent bacteria growing in the composition—this may not be required if other components of the composition are sufficiently concentrated to kill bacteria. Exemplary biocides include 1,2-benzisothiazolin-3-one and Proxel GXL™ available from Zeneca Specialties.

For use in solvent based systems a degassing agents may be included at up to 0.3 wt % in the jetted composition. This can serve to either scavenge or release dissolved gas from the fluid vehicle. Dissolved gas limits the maximum reliable firing frequency by creating air bubbles in the print head during operation. Suitable degassing agents include cyclohexanone oxime and Surfynol DF75™ from Air Products.

The finishing composition may further comprise a pH modifier, preferably present at up to 1 wt % in the jetted composition. The pH modifier may be used to maintain a pH at which the solids of the composition are stably dispersed, typically this is pH>7, so most modifiers are alkaline. The pH modifier may also be used to affect the chemistry of the interaction between the composition/active agent and the textile itself. Ammonia, morpholine, diethanolamine, triethanolamine and acetic acid are suitable pH modifiers. Generally, it is desirable from an inkjet perspective to use relatively neutral solutions to reduce corrosion in the print heads. Where the chemistry dictates the need for e.g. highly alkaline solutions, ceramic (piezo) print heads may be used.

The finishing composition may also further comprise a corrosion inhibitor, preferably present at up to 0.2 wt % in the jetted composition. The corrosion inhibitor may be used to prevent unwanted ions present in the fluid (usually as impurities coming from the active components) from causing corrosion of the printer.

According to a still further aspect of the present invention, the finishing agent may be chosen for its ability to withstand shear without degradation. In particular it should be stable to shear up to at least 105/s. Inkjet deposition is a high shear technique and so material that is not stable to high shear may decompose and block the print head nozzle and may also cease to provide the desired application or end user properties on the substrate. While the present invention is directed to finishing compositions for DoD, it is nevertheless considered that the composition would also be suitable for other jet deposition techniques where similar conditions of pressure, shear and nozzle diameter are encountered such as valve-jet type devices.

According to an alternative embodiment of the invention, the finishing composition may be based on a UV curable organic diluent, preferably present at between 75 and 95 wt % in the jetted composition. Such UV curing compositions are quick to cure, extremely durable and are ideal as carriers for certain agents. Particular to UV curing compositions is that substantially the total of the deposited material remains on the substrate. A solvent may however sometimes be added to reduce viscosity although generally this is not preferred. For UV cure finishing composition a photo-initiator may preferably be present at between 3 and 20 wt % in the jetted composition.

The finishing agent may be any appropriate agent that can endow a functional property to a textile substrate. In particular it may be selected from the group consisting of anti-static, anti-microbial, anti-viral, anti-fungal, medicinal, anti-pilling, non-crease, flame-retardant, water-repellant, UV-protective, deodorant, wear-resistant, slip-resistant, slip enhancing, grip enhancing, stain-resistant, oil resistant, adhesive, stiffening, softening, elasticity-enhancing, pigment-binding, conducting, semi-conducting, photo-sensitive, photo-voltaic and light-emitting agents.

For use with drugs or medicinal or biologically active agents a carrier may be used and the agent may be jetted at low temperatures e.g. below 40° C. Appropriate carriers include cyclodextrines, fullerenes, aza-crown ethers and also polylactic acid (PLA). These carriers are ideally suited for attachment both to the textile fibres and to the agent. A review of these carriers is to be found in an article by Breteler et al. in Autex Research Journal, Vol. 2 No 4 entitled Textile Slow Release Systems with Medical Application, the contents of which are hereby incorporated by reference in their entirety. Alternate carriers, particularly for use with nano-particles, may be sol gel systems.

In another embodiment, the coating is a water-repellent coating and the coating composition comprises a fluorocarbon or silicon based emulsion, an anti-foaming medium, an electrolyte and a thickener. By applying such a coating in an open structure with pores between adjacent pixels, a breathable structure may be achieved.

According to an important feature of the present invention, the treatment path may comprise a conveyor and the textile may be affixed to the conveyor, whereby the position of the textile relative to the conveyor may be maintained. In this way, when the precise location of each pixel is important, shifting of the textile may be prevented. This is particularly important when the treatment includes printing using different colours applied by different rows of nozzles. The textile may be affixed to the conveyor by means of adhesive or the like.

The invention also relates to a method of finishing a textile comprising: providing a continuous supply of a textile substrate; providing an array of drop-on-demand inkjet nozzles; supplying to the nozzles a finishing composition according to any of the preceding claims; selectively dispensing the composition from the nozzles in a series of droplets to deposit a predetermined distribution of droplets onto the substrate.

According to a feature of the method, the droplets may be dispensed from the nozzles at velocities between 5 and 15 m/s. The droplets may also be formed at frequencies of up to 30 KHz.

Preferably the nozzles are of the piezo-electric type. Such nozzles are considerably cheaper than CIJ nozzles and are less sensitive to the physical characteristics of the composition used. In particular, since greater viscosity and percentages of solids can be used, higher concentrations of active components may be jetted. Furthermore, for sensitive agents, less shear is encountered and by using ceramic heads, otherwise corrosive products may be handled.

Alternatively, thermal print heads may be employed in cases where exposure to high temperature is not at issue or is otherwise desirable. It is also considered that valve-jet devices in which microscopic valves are periodically opened and closed could provide similar functionality when used with similar compositions as defined herein.

Also preferable is that more than 30 g/m2 of wet composition is deposited on the substrate, more preferably around 50 g/m2.

The invention further relates to a textile article provided with a finish comprising the finishing composition as defined above or finished according to the method of the invention.

Further, the present invention also relates to a device for digitally coating a textile, the device comprising a conveyor for substantially continuously feeding the textile along a treatment path, a row of static coating nozzles arranged generally transversely across the path, for applying a coating composition over substantially the complete width of the textile, wherein the coating nozzles have outlet diameters of greater than 70 microns and are individually controlled to provide a substantially continuous stream of droplets that can be selectively directed to impinge on the textile..

According to an advantageous embodiment, the device may additionally comprise a second or further rows of nozzles arranged generally transversely across the path, for applying a further substance to the textile. For performing a different finishing step such as dying or printing, the second row of nozzles may have outlet diameters of less than 70 microns, preferably about 50 microns. They are preferably also individually controlled to provide a substantially continuous flow of droplets that can be selectively directed to impinge on the textile.

According to a particular embodiment of the device, rows of nozzles may be arranged on both sides of the path for coating or otherwise applying substances to both surfaces of the textile.

In order to adequately and accurately perform the operation across the full width of the textile, each row of nozzles is provide on a printing beam spanning the treatment path. Preferably, each beam comprises a plurality of heads, each head comprising a number of nozzles. By using separate heads, the pressure distribution between individual nozzles may be carefully controlled. In particular, using around eight nozzles per head, adequate pressure control to each nozzle is ensured. In such case, a total of between 10 and 100 heads may be provided on each beam.

According to a preferred embodiment, the nozzles are of the multi-level deflection ink-jet type, whereby the position of a droplet on the textile may be controlled. Alternatively, some or all of the rows of nozzles may be of the binary deflection ink jettype, whereby a droplet exiting the nozzle can be selectively directed onto the textile or into a collector. Whichever type of nozzle is used, it is desirable that they can be controlled to each generate at least 100,000 droplets per second in order to achieve the required process speed.

Preferably, the conveyor is wide enough to accommodate textiles of more than 1 meter in width, more preferably up to about 2 meters in width. It should also be arranged to operate at a speed of more than 15 meters per minute, more preferably at more than 25 meters per minute. It may also be provided with adhesive or the like for preventing relative movement of the textile.

The present invention further relates to a digitally coated fibrous textile having mesh openings between adjacent fibres, the fibres having an average spacing of greater than 40 microns, the textile being provided with a coating comprising a plurality of pixels of coating material lying substantially on the surface of the textile, each pixel covering at least four mesh openings and having a diameter of more than 100 microns. Preferably, the textile is a woven or knitted textile.

According to further particular embodiments of the invention, the textile may have a width of greater than 1.5 meters. Furthermore, the coating may be provided in the form of a closed coating with overlapping pixels or in the form of an open coating with pores between adjacent pixels.

### BRIEF DESCRIPTION OF THE DRAWINGS

The invention will now be described in further detail with reference to a number of exemplary embodiments according to the annexed figures, in which:

FIG. 1 shows a schematic block diagram of the process of upgrading a substrate;

FIG. 2 shows a view in perspective of a textile upgrader including a coating device according to the present invention;

FIG. 3 is a schematic side view of the textile upgrader of FIG. 2;

FIG. 4 is a schematic front view of the textile upgrader of FIG. 2;

FIG. 5 is a cut-away schematic view of the textile upgrader of FIG. 2;

FIG. 6 is a schematic representation of a preferred sequence for performing the different treatment steps;

FIG. 7 is a schematic representation of an alternative preferred sequence for performing the upgrading steps;

FIG. 8 is a schematic representation of a further preferred sequence for performing the upgrading steps;

FIG. 9 shows a schematic view of a portion of woven textile coated according to the invention;

FIG. 10 is a cross section through the textile of FIG. 9 along the line 10-10; and

FIG. 11 shows a similar view to FIG. 10 through a coated textile in which smaller droplets have been used.

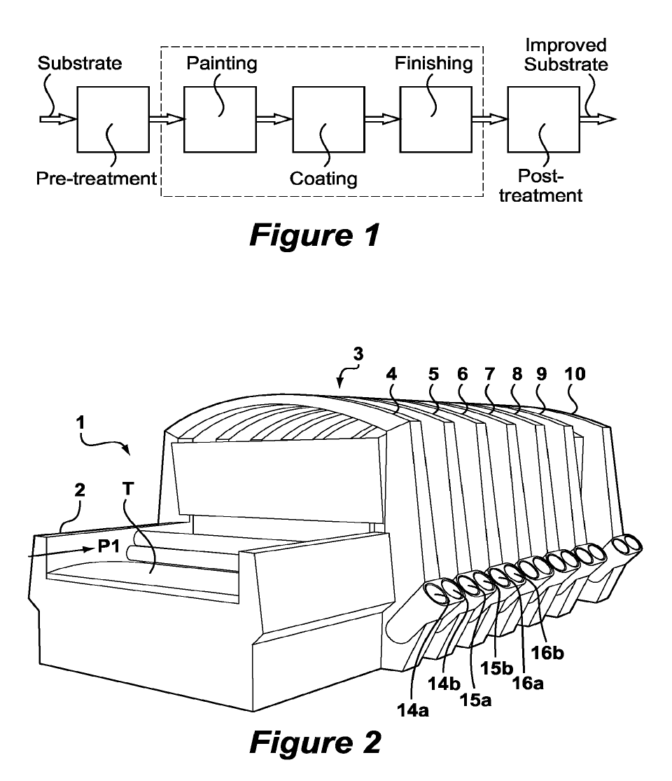

### DESCRIPTION OF ILLUSTRATIVE EMBODIMENTS

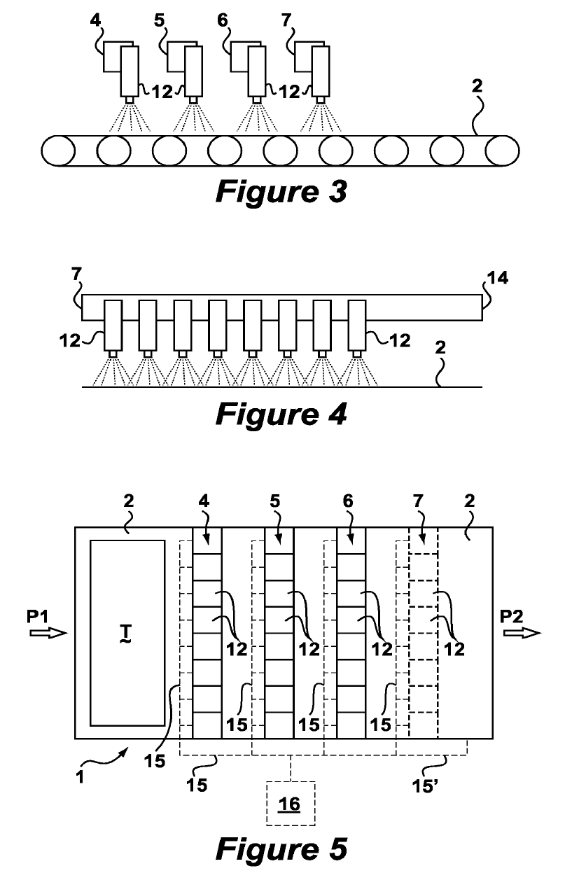

The following is a description of certain embodiments of the invention, given by way of example only and with reference to the drawings. FIGS. 2-5 show a textile upgrader 1 according to a preferred embodiment of the invention. Textile upgrader 1 is built up of an endless conveyor belt 2 driven using electric motors (not shown). On conveyor belt 2 can be arranged a textile article T which can be transported in the direction of arrow P1 along a housing 3 in which the textile undergoes a number of operations. The textile is physically affixed to the conveyor by means of an adhesive to prevent shifting of the textile during the process. Finally, the textile is discharged in the direction of arrow P2 by release of the adhesive. A large number of nozzles 12 are arranged in housing 3. The nozzles are arranged on successively placed parallel beams 14. A first row 4, a second row 5, a third row 6 and so on are thus formed. The number of rows may vary (indicated in FIG. 5 with a dotted line) and depends on e.g. the desired number and nature of the operations. The number of nozzles per row is also variable and depends among other things on the desired resolution of the designs to be applied to the textile. In the illustrated embodiment, the effective width of the beams is about 1 m, and the beams are provided with about 29 fixedly disposed spray heads, each having about eight nozzles per head. Each of the nozzles 12 generates a stream of droplets of substance.

In the preferred continuous inkjet method, pumps carry a constant flow of ink or other medium through one or more very small holes of the nozzles. In the following, although reference will be made to ink and inkjet, this is understood not to be limiting and that other substances may also be ejected from the nozzles. One or more jets of ink, inkjets, are ejected through these holes. Under the influence of an excitation mechanism such an inkjet breaks up into a constant flow of droplets of the same size. The most used excitator is a piezo-crystal although other forms of excitation or cavitation may be used. From the constant flow of droplets of the same size which are now generated must be selected those droplets which are to be applied to the substrate of the textile and those which should not be applied. For this purpose the droplets are electrically charged or discharged. There are two variations for arranging droplets on the textile. According to the one method an applied electric field deflects the charged droplets, wherein the charged droplets come to lie on the substrate. This method is also referred to as binary deflection. According to another preferred method, also known as the multi-level method, the electrically charged droplets are usually directed to the textile and the uncharged droplets are deflected. The droplets are herein subjected to an electric field which is varied between a plurality of levels such that the final position at which the different droplets come to lie on the substrate can hereby be adjusted.

In FIG. 5 is indicated with dotted lines that the different nozzles 12 are connected electrically or wirelessly) by means of a network 15 to a central control unit 16, which comprises for instance a microcontroller or a computer. The drive of the conveyor belt 2 is also connected to the control unit via network 15′. The control unit can now actuate the drive and the individual nozzles as required.

Also arranged per row of nozzles 4-11 is a double reservoir in which the substance to be applied is stored. The first row of nozzles 4 is provided with reservoirs 14a, 14b, the second row 5 is provided with reservoirs 15a, 15b, the third row 6 is provided with reservoirs 16a, 16b and so on. The appropriate substance is arranged in at least one of the two reservoirs of a row.

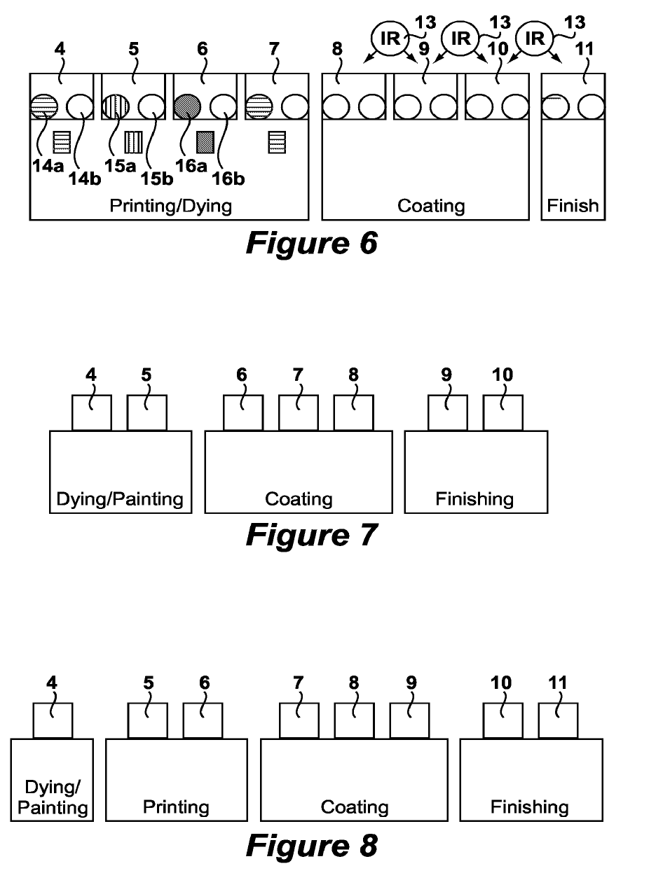

The different reservoirs are filled with appropriate substances and the nozzles 12 disposed in different rows are directed such that the textile article undergoes the correct treatment. In the situation shown in FIG. 6, reservoir 14a of the first row 4 contains cyan-coloured ink, reservoir 15a of the second row 5 contains magenta-coloured ink, reservoir 16a of the third row 6 contains yellow-coloured ink and reservoir 17a of the fourth row 7 contains black coloured ink. The textile article is provided in rows 4-7 with patterns in a painting/printing treatment. The nozzles in these rows have outlet diameters of about 50 microns. The reservoirs of the three subsequent rows 8-10 contain one or more substances with which the treated textile can be coated in three passages for the purpose of coating the textile, the nozzles in rows 8-10 have outlet diameters of 70 microns. The eighth reservoir 11 contains a substance with which the printed and coated textile can be finished. In this embodiment the textile article T is preferably treated at the position of the fifth to the eighth row with infrared radiation coming from light sources 13 in order to influence the coating of the finishing.

FIG. 7 shows another situation in which the textile undergoes another treatment sequence. The textile article T is first of all painted by guiding the textile along the first row 4 and second row 5 of nozzles. These rows 4, 5 have nozzles of 70 microns and apply a relatively smooth coloured coating onto the textile. In the third to fifth rows 6-8 the painted textile is then coated as above, whereafter the finishing step is carried out in the sixth and seventh rows 9,10.

In the embodiment shown in FIG. 8, the textile article is first of all guided along the first row 4 of nozzles. The nozzles in row 4 are of about 70 microns and provide a smooth full background colour to the textile over the full width. The textile article is subsequently guided along the second row 5 and third row 6 by means of the conveyor belt, wherein patterns are printed onto the prepared surface. Good definition can be achieved in the printing steps at rows 5 and 6 using fine nozzles of between 30 and 50 microns. The textile is then guided along the fourth to sixth rows 7-9 to coat the painted and printed textile in three passages, whereafter a final finishing treatment step is performed in the seventh and eighth rows 10, 11.

It is possible to treat different successively transported textile articles in different ways, in some cases even without the transport of the textile therein having to be interrupted. It is for instance possible by means of computer control of nozzles 12 to provide successively supplied textile articles with designs which differ in each case. It is also possible to have different substances applied to the textile through an appropriate choice of the reservoirs. The first reservoirs 14a, 15a, 16a are for instance used in each case for a first type of textile, while the second reservoirs 14b, 15b, 16b are used for another type of textile.

In order to determine the environmental advantages of the present invention, use can be made of an example of a representative upgrading process in which a substrate passes through four cycles of unit operations for the purpose of painting, followed by four cycles for the coating and finally two cycles for the finishing. The quantification is based on the production of a 1,800 metre long and about 1.6 metre wide substrate of bleached and dried cotton with a weight of 100 grams per square metre of substrate. The painting, coating and finishing are herein each performed in one process run, with the necessary post-treatments and/or pre-treatments between these process runs. If the treatments can be carried out in one process run, the environmental advantages will therefore be even greater.

In the traditional upgrading process, practically every component (painting, coating and finishing) takes place in and/or with a highly aqueous solution. In the digital process according to the invention a highly concentrated solution is sprayed directly onto the substrate with a precisely controlled dosage. Less water is hereby used. For the purpose of rinsing/washing out excess chemicals and auxiliary chemicals, practically every cycle of unit operations comprises a rinsing step. The number of rinsing steps can be reduced from ten in the existing process (four times painting, four times coating and twice finishing) to three in the present digital process (i.e. once painting, once coating and once finishing). Seven fewer rinsing steps are therefore needed. This means that a considerable reduction in the water consumption can already be realized by curtailing the rinsing. The total reduction in the water consumption is in many cases more than 90%.

The energy consumption can also be reduced considerably, since among other things forced drying is not necessary, or is only necessary to a very limited extent, rinsing with hot/warm rinsing water is not necessary, or only to a very limited extent, and the mechanical handling of the substrate is very greatly reduced.

In the known upgrading process drying usually takes place between the different unit operations, and also within operations when a cycle has to be carried out a number of times. The substrate can contain up to several times its own weight of water. Drying generally takes place in two phases. In the first phase the greater part of the water is removed from the substrate mechanically. In the second phase there follows thermal drying, wherein the remaining water present in the substrate is evaporated.

Because the present digital upgrading process is performed almost without water, no water, or practically no water, has to be evaporated, such as for instance by drying, between the different upgrading steps and after the final upgrading step. A very considerable energy-saving is hereby realized. The limited drying which is necessary in some cases can be realized in most cases by means of directional UV driers. In general as little as 70% water by weight may be required for the coating substance.

In digital processes, because of the very limited washing of the substrate required it will also be possible to considerably reduce the number of mechanical operations, including transport of the substrate between the different upgrading operations, compared to the known upgrading process. The electrical energy consumption will hereby also decrease considerably. In total, a reduction in the energy consumption by more than 90% may be realized.

With current production techniques about 150 grams of wet substances (chemicals) are applied per square metre. In digital printing, owing to more precise dispensing, lower pressure and less absorption in the textile, the quantity of chemical substances to be applied can be reduced to about 50 grams of wet substance per square metre. It is hereby possible to make a saving of about 66% in the chemicals. The saving relates not only to the primary chemicals but also to the additives, such as salts, with which the substrate is pre-treated in the digital process in order to facilitate the action, fixation and/or reactivity of the primary chemicals. It is expected that a saving of 66% can also be made on these additives. Finally, the waste water production and the contamination impact of the waste water can be reduced by more than 90%.

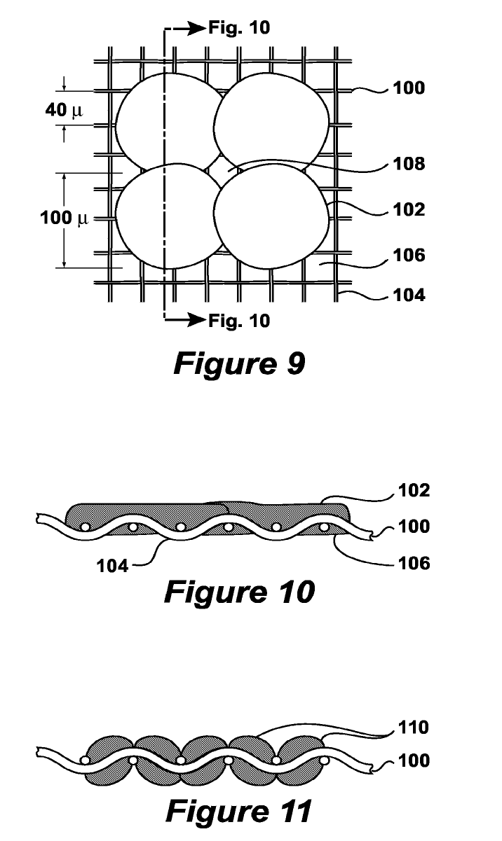

FIG. 9 shows a schematic view of a portion of woven textile 100 on which four pixels 102 of a coating material have been deposited. The textile 100 comprises fibres 104 arranged in a mesh with mesh openings 106 between the fibres 104. The fibre spacing is approximately 40 microns and the pixels 102 each have a diameter of approximately 100 microns. As can be seen from FIG. 9, each pixel 102 effectively covers at least four complete openings 106. Additionally, it can be seen that the pixels 102 do not form a completely closed coating in that a pore 108 is formed between adjacent pixels 102.

FIG. 10 is a cross section through the textile 100 of FIG. 9 along the line 10-10. It can be seen that the pixels 102 are generally located on the surface of the textile, spanning the openings 106 between adjacent fibres 104. Because of the viscose nature of the coating substance, each pixel 102 partially maintains its shape and although the pixels 102 flow together in the overlap region, the individual pixels are still discernable. It can furthermore be seen that the coating substance forming the pixel 102 partially envelopes the fibres 104 on the coated surface to form a good bond therewith. The viscosity of the coating substance is chosen to ensure the correct degree of impregnation of the material.

FIG. 11 shows a similar view to FIG. 10 taken through a textile 100 in which smaller droplets 110 of a coating substance have been applied. The droplets 110 are of a similar size to the mesh opening 106 and tend to pass into and even through the openings. The resultant effect is less homogenous than in the case of FIG. 10 and it is also more difficult to provide a different characteristic to the opposite facing surfaces of the textile.

While FIGS. 9 and 10 illustrate the case of a textile weave of approximately 40 microns, it is also within the scope of the invention that even coarser weaves or structures may be used.

While the above examples illustrate preferred embodiments of the present invention it is noted that various other arrangements may also be considered which fall within the spirit and scope of the present invention as defined by the appended claims.

What is claimed is:

1. A finishing composition for deposition by drop-on-demand inkjet technique onto a textile substrate, the composition comprising a dispersion or emulsion of a functional finishing agent in a vehicle, wherein the size of particles in the dispersion or emulsion of the finishing composition is less than 2 microns and not subject to flocculation or sedimentation and wherein the total of residual solids of functional finishing agent in the jetted composition is more than 10 wt %.

2. The finishing composition according to claim 1, further comprising a wetting agent.

3. The finishing composition according claim 1, wherein the surface tension of the composition on deposition is between 28 and 50 dynes/cm.

4. The finishing composition according to claim 1, wherein the composition is suited for piezo-actuation and has a viscosity of 2-15 centipoise, as measured at the normal operating temperature of the nozzle.

5. The finishing composition according to claim 1, wherein the total of residual solids in the jetted composition is more than 15 wt %.

6. The finishing composition according to claim 1, wherein the vehicle is water.

7. The finishing composition according to claim 1, further comprising a co-solvent.

8. The finishing composition according to claim 1, further comprising a humectant.

9. The finishing composition according to claim 1, further comprising a viscosity control agent.

10. The finishing composition according to claim 1, further comprising a biocide.

11. The finishing composition according to claim 1, further comprising a pH modifier.

12. The finishing composition according to claim 1, further comprising a corrosion inhibitor.

13. The finishing composition according to claim 1, wherein the vehicle is a UV curable organic diluent.

14. The finishing composition according to claim 13, further comprising a photo-initiator.

15. The finishing composition according to claim 1, wherein the finishing agent is stable to shear up to at least 105/s.

16. The finishing composition according to claim 1, wherein the finishing agent is selected from the group consisting of anti-static, anti-microbial, anti-viral, anti-fungal, medicinal, anti-pilling, non-crease, flame-retardant, water-repellant, UV-protective, deodorant, wear-resistant, slip-resistant, slip enhancing, grip enhancing, stain-resistant, oil resistant, adhesive, stiffening, softening, elasticity-enhancing, pigment-binding, conducting, semi-conducting, photo-sensitive, photo-voltaic and light-emitting agents.

17. The finishing composition according to claim 1, wherein the finishing agent comprises nano-particles carried by a gel.

18. A method of finishing a textile comprising:
providing a continuous supply of a textile substrate;
providing an array of drop-on-demand inkjet nozzles;
supplying to the nozzles a finishing composition according to claim 1;
selectively dispensing the composition from the nozzles in a series of droplets to deposit a predetermined distribution of droplets onto the substrate.

19. The method according to claim 18, whereby the droplets are dispensed from the nozzles at velocities between 5 m/s and 15 m/s.

20. The method according to claim 18, whereby the droplets are formed at a frequency of greater than 30 KHz.

21. The method according to claim 18, wherein the nozzles are of the piezo-electric type and droplets are formed by piezo-electric excitation.

22. The method according to claim 18, wherein the nozzles are of the thermal inkjet type and droplets are formed by localized vaporisation.

23. The method according to claim 18, wherein the nozzles are of the valve-jet type and droplets are formed by periodically opening a valve.

24. The method according to claim 18, wherein more than 30 g/m² of wet composition is deposited on the substrate.

25. A textile article provided with a finish comprising the finishing composition according to claim 1 or finished according to the method of claim 18.

26. The finishing composition according to claim 1, wherein the size of particles in the dispersion or emulsion of the finishing composition is less than 1 micron.

27. The finishing composition according to claim 2, wherein the wetting agent is present at from 0.01 to 0.3 wt % in the jetted composition.

29. The finishing composition according to claim 6, wherein the water is present at between 60 and 90 wt % in the jetted composition.

30. The finishing composition according to claim 7, wherein the co-solvent is present at up to 20 wt % in the jetted composition.

31. The finishing composition according to claim 8, wherein the humectant is present at from 10 to 35 wt % in the jetted composition.

32. The finishing composition according to claim 9, wherein the viscosity control agent is present at from 2 to 15 wt % in the jetted composition.

33. The finishing composition according to claim 10, wherein the biocide is present at up to 0.5 wt % in the jetted composition.

34. The finishing composition according to claim 11, wherein the pH modifier is present at up to 1 wt % in the jetted composition.

35. The finishing composition according to claim 12, wherein the corrosion inhibitor is present at up to 0.2 wt % in the jetted composition.

36. The finishing composition according to claim 13, wherein the UV curable organic diluent is present at between 75 and 95 wt % in the jetted composition.

37. The finishing composition according to claim 14, wherein the photo-initiator is present at between 3 and 20 wt % in the jetted composition.

38. The method according to claim 24, wherein more than 50 g/m² of wet composition is deposited on the substrate.

39. The finishing composition according to claim 1, wherein the composition is suited for thermal-actuation and the viscosity is 1-4 centipoise, as measured at the normal operating temperature of the nozzle.

40. A finishing composition for deposition by drop-on-demand inkjet technique onto a textile substrate, the composition comprising a solution, dispersion or emulsion of a functional finishing agent in a vehicle, wherein the size of particles in the dispersion or emulsion of the finishing composition is less than 2 microns and not subject to flocculation or sedimentation, and wherein the total of residual solids of functional finishing agent in the jetted composition is more than 10 wt %.

41. A finishing composition for deposition by drop-on-demand inkjet technique onto a textile substrate, the composition comprising a functional finishing agent in a binder system, wherein the size of particles in the dispersion or emulsion of the finishing composition is less than 2 microns and not subject to flocculation or sedimentation and wherein the total of residual solids of functional finishing agent in the jetted composition is more than 10 wt %.

42. The finishing composition of claim 41, wherein the functional finishing agent comprises a fire-retardant.
